(19) United States
(12) Patent Application Publication
(10) Pub. No.: US 2020/0056130 A1
(43) Pub. Date: Feb. 20, 2020

(54) FERMENTATION AND/OR STORING TANK

(71) Applicant: NOFORM SRL, Meolo (IT)

(72) Inventor: Bruno CROSATO, Meolo (IT)

(21) Appl. No.: 16/343,007

(22) PCT Filed: Oct. 15, 2017
(86) PCT No.: PCT/IB2017/056390

§ 371 Date: Apr. 18, 2019

(30) Foreign Application Priority Data
Oct. 19, 2016 (IT) 102016000105208

(51) Int. Cl. C12G 1/02

(52) U.S. Cl. CPC C12G 1/02

(57) ABSTRACT

A method is described for manufacturing a container (MC) for fermentation and/or storage of a vegetable product, particularly wine or must, comprising the steps of
placing a wooden vat (11), constituting a closed fermentation and/or storage cell, over a second closed fermentation and/or storage cell (50).

The invention relates to a fermentation and/or storage tank, and the method of making it.

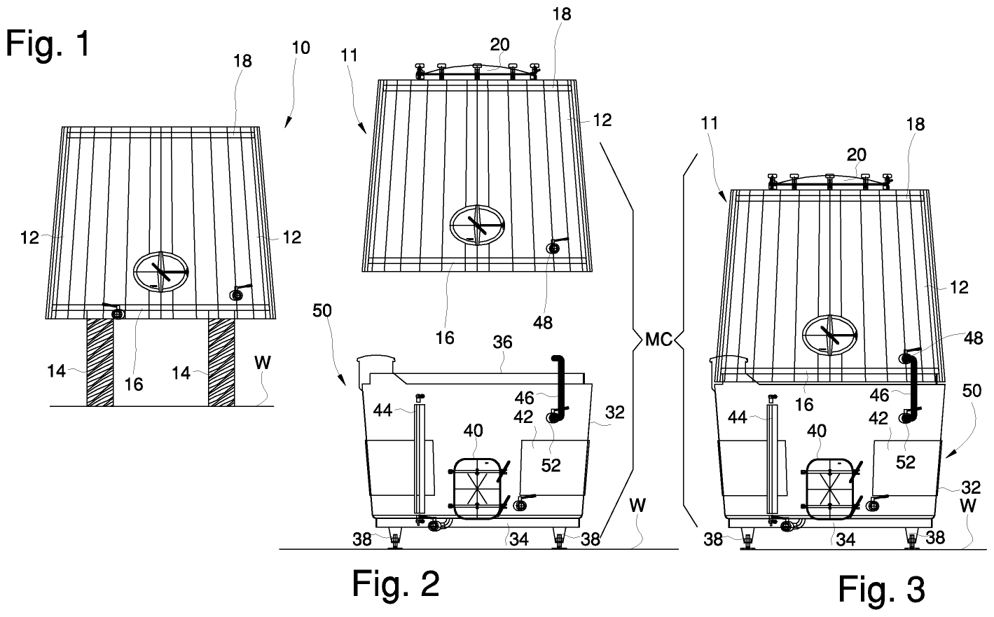

Especially in the wine field, it is known that the wooden vat is a traditional vessel for the fermentation of must with or without marc. A common vat 10 is as shown in FIG. 1. The vat 10 is made of wooden strips 12, called slats, generally made of oak, planed and held together by metal circles. The bottom 16 and the top 18 of the vat 10 are constituted of a circle of wood or metal, and all the vat 10 is raised from the ground by legs 14, e.g. wooden logs. Recently, the legs 14 have evolved into metallic beams, very often height-adjustable.

In fact, the wooden vat 10 offers good wine-making performance, so much so that sophistications are born to ease its use. For example, in order to facilitate the maintenance of a wooden shell, there are steel bottomed and topped vats decomposable into three stacked pieces as shown in EP1948778. However, during assembly, which is quite complicated, the vat remains useless thereby decreasing the production capacity of the winery. Also, it is needed to structurally modify the wooden part, and the resulting container has only one hybrid fermentation or storage cell, in the sense that the cell is composed of different materials at different heights. Thus, the fermentation in a completely wooden environment is lost.

The main object of the present invention is to improve this state of art.

Another object is to provide a method or container to increase the production capacity in a winery without increasing the area occupied by vats. Another object is to provide a method or container to enhance the processing capabilities for a wooden vat.

A first aspect of the invention relates to a method as in the appended claims. The method is for making a fermentation and/or storage container for a vegetable product, particularly wine or must, and comprises the step of

placing a wooden vat, constituting a closed fermentation and/or storage cell, over a second closed fermentation and/or storage cell.

Thus, in the composite container the wine-making properties of the wooden cell are maintained the capacity is expanded with a second cell. Although the cells can be spaced apart and detached from each other, for constructive simplicity and structural resistance preferably the vat is leant on, and in direct contact with, the second cell. Not only a wooden vat can be re-styled with the second cell, but the winery's space is exploited to the maximum vertically, without additional area.

For stability and compactness, preferably the ceiling of the second cell is dimensioned to substantially mate with the wooden vat's bottom, in particular the ceiling of the second cell has the same plan as the bottom of the wooden vat.

To simplify the relative assembly of the ceiling of the second cell and the bottom of the wooden vat, the ceiling of the second cell is inserted into a complementary cavity present in the bottom of the wooden vat.

In a preferred variant, the two cells are put into communication so that some product can be poured from the first cell into the second cell. In a even more preferred variant, the two cells are put into communication via a conduit external to the cells.

Another aspect of the invention relates to a container as in the attached claims. The container for fermentation and/or storage of a vegetable product, in particular wine or must, comprising a wooden vat, constituting a first closed fermentation and/or storage cell bounded by

a wooden side wall,

a wooden or metal or plastic bottom,

and a wooden or metal or plastic cover,

is characterized by comprising

a second closed fermentation and/or storage cell, made of material other than wood, placed to support the first cell.

Preferably, in the container the second cell is made of metal or plastic, for constructive simplicity.

Preferably, the second cell is under—and in direct contact with—the first cell, for constructive simplicity and maximum exploitation of the winery's volume.

Preferably, the second cell comprises a ceiling of shape and area substantially equal to the bottom of the first cell, for maximum stability and holding capacity.

To simplify the relative assembly of the ceiling of the second cell and the bottom of the wooden vat, the wooden vat or first cell comprises a protruding edge extending from the bottom transversely (e.g. orthogonally) with respect to the lying plane of the bottom. The edge and the bottom define this way a cavity with shape complementary to the ceiling or the top of the second cell, and the top or the ceiling of the second cell ceiling can be inserted into the cavity.

Preferably, the second cell comprises a thermoregulation pocket or means for a vegetable product fermenting or stored in the second cell.

Preferably, the second cell comprises an access hatch.

Preferably, the second cell externally comprises a level rod capable of displaying the product's level within the second cell.

Preferably, the container comprises a duct external to the cells connecting the two cells so that the product can be decanted (e.g. by gravity) from the first cell into the second cell. In order to adjust the product flow on the duct preferably valves are present.

Preferably, the container comprises a duct connecting the two cells so that some product or liquid can be poured from the second cell inside the first cell. In particular, the container may comprise means for pressurizing the second cell and means for regulating the flow within said duct (e.g. a valve), so that the product or liquid can be injected from the first cell to the second cell under the thrust of the pressure present in the second cell. Such pressure e.g. is generated by the same fermentation gas or by injection of gas into the second cell from the outside.

Preferably, the container comprises a cap-breaking carriage arranged on the ceiling of the first cell, to increase the possible processing through a cap-breaking piston rod fitted on the carriage. As an advantageous option, the container comprises horizontal rails mounted on the ceiling of the first cell for the sliding of the cap-breaking member. Various containers can be e.g. aligned, and the guides or rails are straight for the sliding of the carriage from a first cell of a container to the first cell of an adjacent container. Or various containers can be adjacent in random order, and the guides or rails are straight and/or curved for the sliding of the carriage from a first cell of a container to the first cell of an adjacent container.

Preferred embodiments of the invention will now be described with reference to the attached drawing, wherein

FIG. 1 shows a wooden vat of known type;

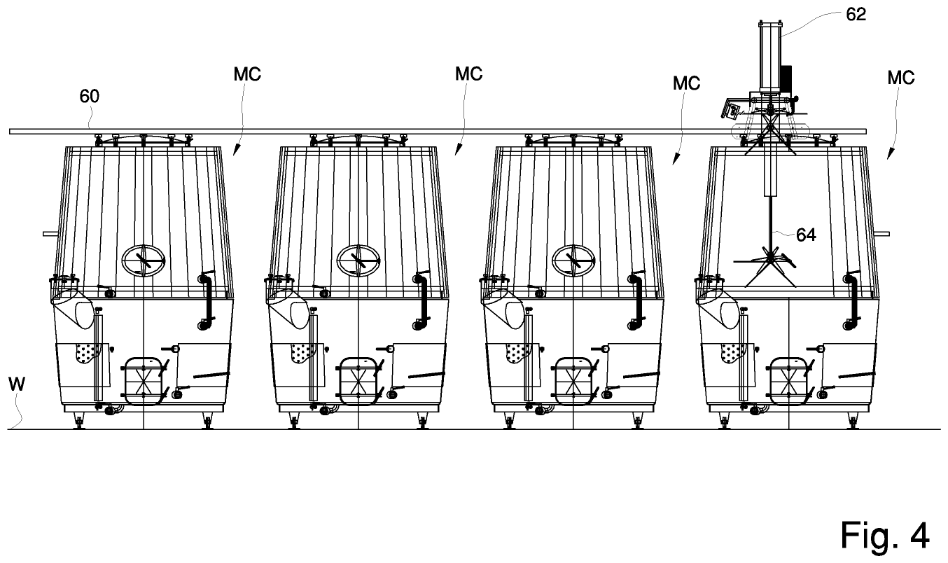

FIG. 2 shows a partially exploded front view of a container according to the invention;

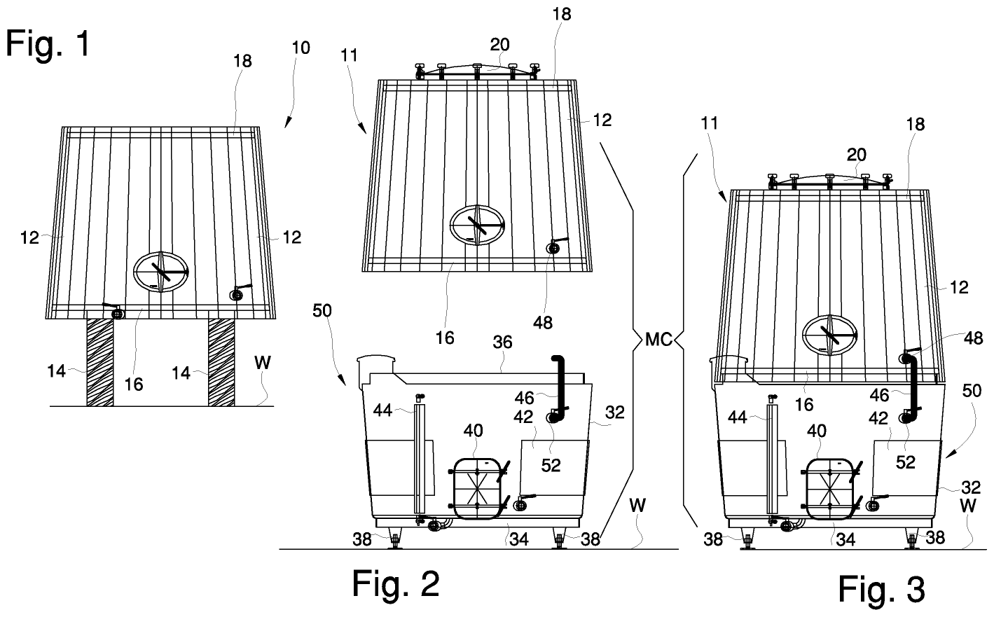

FIG. 3 shows a front view of the container of FIG. 2 when assembled;

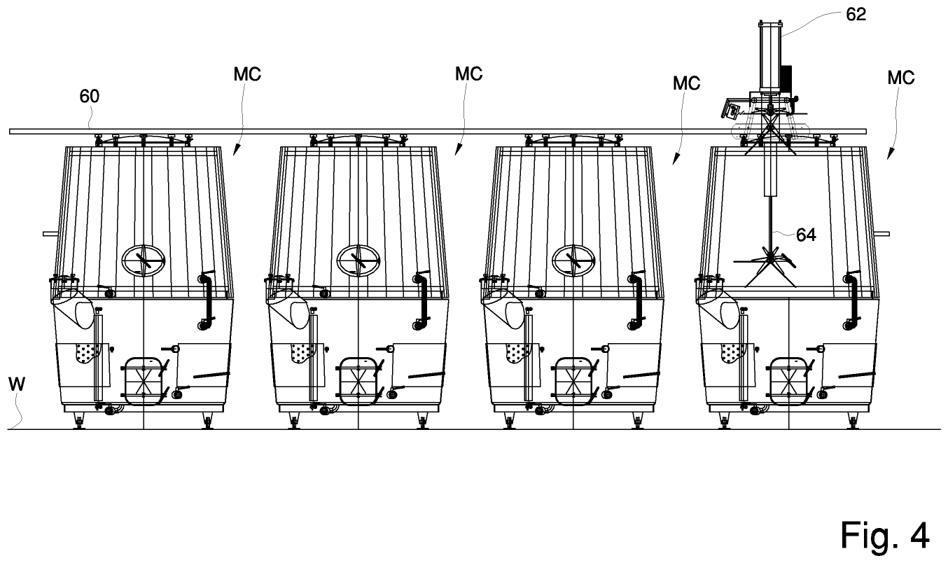

FIG. 4 shows a front view of containers according to the invention.

In the figures, same numbers indicate equal parts, and the container is illustrated and described as in use. A fermentation and/or storage container MC comprises two fermentation and/or storage cells 11, 50, both closed and independent. Fermentation and/or storage is particularly advantageous in the case of must or wine.

The first cell 11, the upper one, is substantially analogous to the wooden vat 10 of FIG. 1. The cell 11 is made of wooden strips 12, generally made of oak, and, for example, held together by metallic circles, and comprises a bottom 16 and a ceiling 18 made up of a wooden or metal panel or circle.

The second cell 50, the lower one, comprises a bottom 34, a ceiling 36, and a cylindrical shell 32 which forms the side walls thereof. The bottom 34, the ceiling 36, and the cylindrical shell 32 are made of a material different from wood, e.g. metal or plastic, and are watertightly connected to each other. Preferably, the bottom 34 rests on a support plane W through sockets 38.

The cells 11, 50 are superimposed one on the other, in particular for maximum mounting simplicity the bottom 16 of the cell 11 rests directly on the ceiling 36 of the cell 50 (FIG. 3).

As can be seen from FIGS. 2 and 3, the cells 11, 50 are stackable one above the other to compose the overall container MC.

The container MC made up of the two cells 11, 50 has many advantages.

It increases the storage capacity per m² and, if the height of the cell 50 is equal to that of the original legs 14, the distance from ground of the cell 11 remains unaltered, and modifications or extensions of the surrounding environment are unnecessary. The legs 14 are saved too, and the interaction between the two cells 11, 50 allows the product contained into the cell 11 to be processed in new ways, i.e. it increases the processing potential and the efficiency of the first cell 11.

From the cell 11 the must or wine can be decanted by gravity into the cell 50 below, e.g. via a conduit 46 which puts the two cells 11, 50 into communication. The pouring is preferably controlled by valves 52, 48 set on the conduit 46. The pouring allows to execute the delestage technique, or to perform a differentiated fermentation in the two cells 11, 50.

To expand the possible product treatments or simplify the processing, the cell 50 preferably comprises:

temperature control means 42, able to adjust the temperature inside the cell 50, as for example. a pocket in the shell 32 in which heating or refrigerant fluid flows; and/or

means for performing a pressurized pumping-over of the product drained from the cell 50 to the cell 11;

a hatch 40 for accessing the inside (or evacuating solid parts); and/or

a device 44 for measuring the level of liquid within the cell 50.

To maximally exploit the capacities of the cells 11, 50 and for ease of assembly, the bottom 16 has the same area and/or plan of the ceiling 36. Or to favour the stable overlap between the two cells 11, 50, the lower edge of the strips 12 (or generally of the side wall of the cell 11) protrudes slightly downwards with respect to the bottom 16. Thus, underneath the cell 11 there is formed a concavity where the top of, or all, the ceiling 36 can be inserted.

FIG. 4 shows a row of containers MC, from which it can be appreciated the huge storage volume recovered by applying to each cell 11 a second cell 50.

Another advantage is the ability to cap-break the product inside the cell 11, and to do so the cell 11 preferably comprises a cover 20 for opening or closing an access in the ceiling 18 through which to insert into the cell 11 a cap-breaking piston 64 of a cap-breaking carriage 62. It is convenient to mount on the ceiling 18 of cells 11 rails or guides 60 put side by side, in order to be able to move the carriage 62, and thus the piston 64, above and inside each cell 11.

1-3. (canceled)

4. Container (MC) for fermentation and/or storage of a vegetable product, in particular wine or must, comprising
a wooden vat (11), constituting a first closed fermentation and/or storage cell bounded by a side wall (12) in wood, a wooden bottom (16), and a wooden cover (18), characterized by comprising
a second closed fermentation and/or storage cell (50), made of material other than wood, placed to support the first cell.

5. Container according to claim 4, wherein the second cell is made of metal or plastic.

6. Container according to claim 4, wherein the second cell is under and in direct contact with the first cell.

7. Container according to claim 6 6, wherein the second cell (50) comprises a ceiling (36) of shape and area substantially equal to the bottom (16) of the first cell (11).

8. Container according to claim 4, wherein the second cell comprises a thermoregulation pocket or means for a vegetable product fermenting or stored in the second cell.

9. Container according to claim 4, comprising a duct (46) external to the cells connecting the two cells (11, 50) so that the product can be decanted from the first cell into the second cell.

10. Container according to claim 4, comprising horizontal rails (60) mounted on a ceiling of the first cell for the sliding of a cap-breaker carriage.
